(19) United States
(12) Patent Application Publication
(10) Pub. No.: US 2009/0218807 A1
(43) Pub. Date: Sep. 3, 2009

(54) QUICK-RELEASE FASTENER

(75) Inventor: Artem SERYI, Wiesbaden (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/358,149

(22) Filed: Jan. 22, 2009

(30) Foreign Application Priority Data
Jan. 23, 2008 (DE) 102008005619.7

(51) Int. Cl. F16L 37/088

(52) U.S. Cl. 285/24

(57) ABSTRACT

A quick-release fastener for connecting automobile pipes includes, but is not limited to a base body having a partially circular cross-section. At least one first rib projects radially inward from the base body to form an anti-rotation element. Furthermore, at least one second rib projects radially inward from the base body to form an anti-rotation element, and the first rib is arranged axially at a distance from the second rib. Due to the quick-release fastener, a fast and simple connection of automobile pipes is possible even with confined installation space.

### CROSS-REFERENCE TO RELATED APPLICATION

This application claims priority to German Patent Application No. 102008005619.7, filed Jan. 23, 2008, which is incorporated herein by reference in its entirety.

### TECHNICAL FIELD

The invention relates to a quick-release fastener with the aid of which automobile pipes of an automobile may be connected to one another rapidly and simply.

### BACKGROUND

A pipe connection with a quick-release fastener is known from DE 20 2005 009 575 U1, in which a first pipe can be pushed over a pipe projection of a second pipe, a clamping ring being pressed into a tapering recess in order to be able to apply a retaining force in the radial direction to pipes which are inserted inside one another. In order to avoid unintentional release of the pipes from one another, the tapering receptacle for the clamping ring must, for example, be locked with the aid of a nut.

A disadvantage with this type of pipe connection is that several complexly configured components are required to produce the connection and during assembly several assembly steps are required to prevent unintentional release. Furthermore, several hand grips are required to connect the two pipes so that assembly is laborious and slow. In particular, it is necessary to grip on the pipe connection from different gripping directions in order to connect the pipes to one another. This is only possible with difficulty if at all in severely confined spatial conditions such as those, for example, inside an engine compartment of an automobile engine.

It is at least one object of the invention to provide a quick-release fastener for connecting automobile pipes, which makes it possible to rapidly and simply connect automobile pipes even under confined spatial conditions. In addition, other objects, desirable features and characteristics will become apparent from the subsequent summary and detailed description, and the appended claims, taken in conjunction with the accompanying drawings and this background.

### SUMMARY

The quick-release fastener according to an embodiment of the invention for connecting automobile pipes comprises a base body having a partially circular cross-section. At least one first rib projects radially inward from the base body to form an anti-rotation element. In addition, at least one second rib projects radially inward from the base body to form an anti-rotation element, wherein the first rib is arranged axially at a distance from the second rib.

Due to this comparatively simple structure of the quick-release fastener, it is possible for the first rib to engage in an undercut of the first pipe while the second rib engages in an undercut of a second pipe so that both pipes are connected to one another by means of the quick-release fastener. Due to the partially circular cross-section of the base body, the quick-release fastener can be placed resiliently in the area of the undercuts. It is therefore possible in principle to connect the two pipes to one another simply and rapidly by a single assembly movement by means of the quick-release fastener. A seal is preferably arranged between two pipes, and the seal can be disposed, for example, in the axial direction between the two popes and is preferably configured to be rubbery-elastic so that a retaining force can be applied via the seal between the pipes and the quick-release fastener. In particular, if the automobile pipes to be connected are configured according to the inner contour of the quick-release fastener in the area of the first rib or the second rib, twisting of the pipes relative to one another can be prevented at the same time. Since the quick-release fastener is configured to be comparatively small, that is, it has a comparatively small radial extension, only a small amount of installation space is required to connect the quick-release fastener to the automobile pipes to be connected.

The base body preferably has two axially extending longitudinal edges. The longitudinal edges have a distance from one another, which is selected in such a manner that the base body may be placed resiliently onto a pipe piece. The nominal diameter of the pipe piece, that is, the largest outside diameter of an optionally contoured pipe piece, can substantially correspond to the inside diameter of the base body. In order to be able to receive the first rib or the second rib, the substantially circular pipe piece has corresponding recesses so that the ribs can abut against the pipe piece in a rotationally secure manner. Screws, nuts, or other locking means are not required to bring about a secure connection of the quick-release fastener to the automobile pipes.

The first rib and/or the second rib particularly preferably have a radially inwardly pointing support edge, which corresponds to a secant of the base body. As a result, ribs are formed which have a high stability even with a small thickness and cannot easily bend. Furthermore, the quick-release fastener can easily be produced, for example, by cold forming. In addition, ribs are thereby formed which are sufficiently large to apply an impression into the lateral rib surfaces, for example, a component number or information about suitable pipe diameters.

Particularly preferably, at least two first ribs and/or at least two second ribs are provided. In this case, in particular respectively two first ribs or two second ribs are each arranged radially opposite to one another. Since one rib is provided on two opposite sides, it is possible to allow only a particularly small amount of play in the anti-rotation element. In particular, if the first rib is formed identically to the second rib, the quick-release fastener can be mounted independently of direction. That is, during assembly there is no need to pay attention to which side of the quick-release fastener is connected to which automobile pipe. This facilitates and speeds up assembly. In principle, it is possible to mount the quick-release fastener blind.

In particular, the base body has two front-side front edges, which are adjoined by the first rib and/or the second rib. The quick-release fastener can therefore have a substantially U-shaped cross section in the circumferential direction so that the quick-release fastener is easy to produce. In particular, the quick-release fastener has no outwardly pointing sharp edges, which must be deburred to prevent injury. This makes it possible to produce the quick-release fastener inexpensively.

The invention further relates to a pipe connection for an automobile comprising a first automobile pipe having a first undercut and a second automobile pipe having a second undercut. The first undercut has a first contouring to form an anti-rotation element. Accordingly, the second undercut has a second contouring to form an anti-rotation element. The pipe connection furthermore has a quick-release closure which can be configured or further developed as described previously. The at least one first rib of the quick-release fastener engages in the first undercut of the first automobile pipe to form the anti-rotation element. Accordingly, the at least one second rib engages in the second undercut to form the anti-rotation element. The pipe connection can therefore be made quickly and simply even with little installation space.

In a preferred embodiment, a pipe connecting piece which tapers in the distal direction for axial insertion into the quick-release fastener is provided in the distal direction relative to the first undercut and/or to the second undercut. Due to the pipe connecting piece which tapers in the distal direction, it is possible to insert the respective automobile pipe in the axial direction into the quick-release fastener. Positioning the quick-release fastener in the radial direction can therefore be avoided. According to the geometry of the installation space, it is possible to choose to place the quick-release fastener onto the two automobile parts simultaneously through the radial direction. If the installation space is not suitable, it is possible to place the quick-release fastener only on one automobile pipe and then put the other automobile pipe in place axially with the aid of the connecting piece which tapers in the distal direction. In particular, if both automobile pipes have a pipe connecting piece which tapers in the distal direction, it is possible to securely and rapidly insert both the first automobile pipe and also the second automobile pipe in the axial direction into the quick-release fastener.

The first automobile pipe preferably has a pipe projection for insertion into the second automobile pipe. Alternatively, the second automobile pipe can have a pipe projection for insertion into the first automobile pipe. This results in increased stability in the area of the pipe projection and allows simple sealing of the two automobile pipes with respect to one another. The pipe projection particularly preferably comprises a seal, which can be placed, for example, radially between the pipe projection and the respectively other vehicle pipe. This makes sealing easy and may at the same time dampen the transmission of vibrations between the individual automobile pipes, with the result that undesirable noise can be avoided during operation of an automobile.

The pipe connection is particularly preferably disposed in an engine compartment of an automobile. Due to the confined spatial conditions in the engine compartment, the pipe connection and the corresponding quick-release fastener are particularly suitable for connecting different automobile pipes. In particular, the pipe connection can be used for pipe systems used for passing preferably charged fresh air for an internal combustion engine and/or air for air conditioning systems and/or cooling water. A secure connection of the automobile pipes is achieved even under suddenly high pressures.

### BRIEF DESCRIPTION OF THE DRAWINGS

The present invention will hereinafter be described in conjunction with the following drawing figures, wherein like numerals denote like elements, and:

FIG. 1a shows a schematic side view of a quick-release fastener according to an embodiment of the invention;

FIG. 1b shows a schematic sectional view of the quick-release fastener from FIG. 1a along the line I to I;

FIG. 2a shows a schematic side view of a first embodiment of a pipe connection with the quick-release fastener from FIG. 1a

FIG. 2b shows a schematic sectional view of the pipe connection from FIG. 2a along the line II to II;

FIG. 3a shows a schematic side view of a second embodiment of a pipe connection with the quick-release fastener from FIG. 1a;

FIG. 3b shows a schematic sectional view of the pipe connection from FIG. 3a along the line III to III;

FIG. 4a shows a schematic side view of a third embodiment of a pipe connection with the quick-release fastener from FIG. 1a; and

FIG. 4b shows a schematic sectional view of the pipe connection from FIG. 4a along the line IV to IV.

### DETAILED DESCRIPTION

The following detailed description is merely exemplary in nature and is not intended to limit application and use. Furthermore, there is no intention to be bound by any theory presented in the preceding background and summary or the following detailed description.

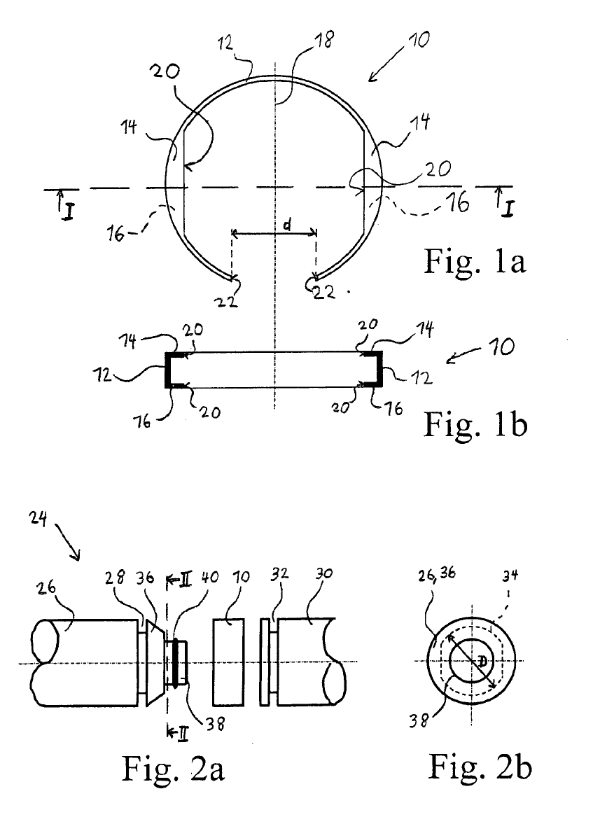

The quick-release fastener 10 shown in FIG. 1a comprises a base body 12 having a partially circular cross section. From the base body 10 two first ribs 14 project radially inward. Spaced apart from the first ribs 14 in the axial direction are two second ribs 16, which also project radially inward from the base body 12. The first ribs 14 and the second ribs 16 are arranged radially opposite to one another in such a manner that the quick-release fastener 10 is configured centro-symmetrically to an axis of symmetry 18.

The first ribs 14 and the second ribs 16 each have an inwardly pointing support edge 20 to form an anti-rotation element. Due to the partially circular cross section, the base body 12 has two axially extending longitudinal edges 22, which have a distance d from one another, which is selected in such a manner that the base body 12 can be placed resiliently onto a pipe piece.

The pipe connection 24 shown in FIG. 2a comprises a first automobile pipe 26 with a first undercut 28. A second automobile pipe 30 with a second undercut 32 is further provided. The first ribs 14 engage in the first undercut 28 in the assembled state while the second ribs 16 engage in the second undercut 32. For this purpose the undercuts 28, 32 have a contouring 34 adapted to the geometry of the quick-release fastener 10 (FIG. 2b), where the nominal diameter D of the contouring 34 is obtained by the largest provided diameter.

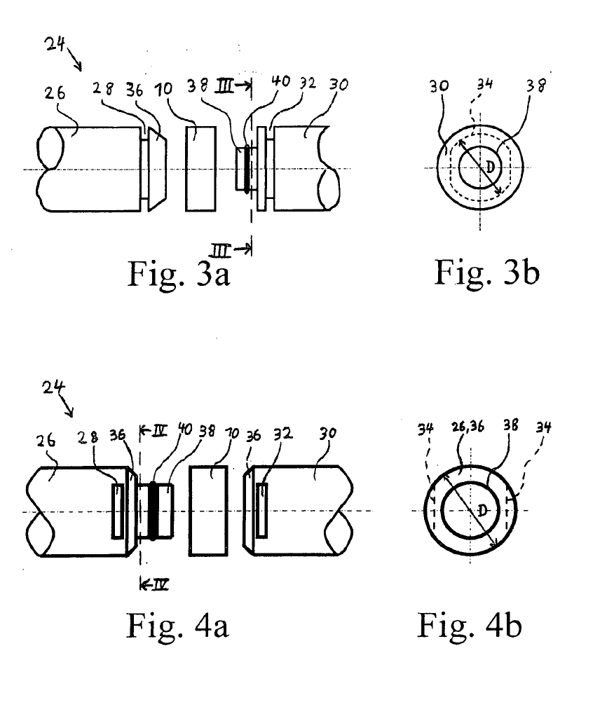

The first automobile pipe 26 furthermore has a pipe connecting piece 36 which tapers in the distal direction so that the first automobile pipe 26 can be inserted simply and quickly into the quick-release fastener 10 in the axial direction. In the exemplary embodiment shown, the first automobile pipe 26 has a pipe projection 38 with a seal 40 by which means the first automobile pipe 26 can be inserted into the automobile pipe 30. In the exemplary embodiment of the pipe connection 24 shown in FIG. 3a, the second automobile pipe 30 has a pipe projection 38 with the seal 40.

In the embodiment of the pipe connection 24 shown in FIG. 4a, the first automobile pipe 26 and the second automobile pipe 30 each have an undercut 28, 32 with the same nominal diameter D as the remaining automobile pipe 26, 30. In this case, the contouring 34 of the undercuts 28, 32 can be formed by simple, optionally milled, segment-shaped recesses without it being necessary to turn the respective automobile pipe 26, 30 in the area of the undercut 28, 32 to a smaller nominal diameter D (FIG. 4).

It is further possible to provide pipe connection 24 with automobile pipes 26, 30 shown in different figures. Differently configured automobile pipes can therefore be combined with one another to form a pipe connection 24 with the aid of the quick-release fastener 10.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed summary and description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A quick-release fastener for connecting pipes of an automobile, comprising:
a base body having a partially circular cross-section;
a first rib that projects radially inward from the base body to form an anti-rotation element; and
a second rib that projects radially inward from the base body to form a second anti-rotation element,
wherein the first rib is arranged axially at a distance from the second rib.

2. The quick-release fastener according to claim 1, wherein the base body has two axially extending longitudinal edges and the two axially extending longitudinal edges have a second distance, which is selected in such a manner that the base body may be placed resiliently onto a pipe piece whose nominal diameter substantially corresponds to an inside diameter of the base body.

3. The quick-release fastener according to claim 1, wherein at least one of the first rib or the second rib have a radially inwardly pointing support edge that corresponds to a secant of the base body.

4. The quick-release fastener according to claim 1, further comprising a third rib arranged radially opposite to the first rib.

5. The quick-release fastener according to claim 1, wherein the base body has two front-side front edges adjoined by at least one of the first rib or the second rib.

6. A pipe connection for an automobile, comprising:
a first automobile pipe having a first undercut with a first contouring to form an anti-rotation element;
a second automobile pipe having a second undercut with a second contouring to form a second anti-rotation element; and
a quick-release fastener comprising:
a base body having a partially circular cross-section;
a first rib that engages the first undercut to form the anti-rotation element; and
a second rib that engages the second undercut to form the second anti-rotation element.

7. The pipe connection according to claim 6, further comprising a pipe connecting piece that tapers in a distal direction for axial insertion into the quick-release fastener and the distal direction relative to at least one of the first undercut or to the second undercut.

8. The pipe connection according to claim 6, wherein the first automobile pipe has a pipe projection for insertion into at least one of the second automobile pipe or the second automobile pipe and has a second pipe projection for insertion into the first automobile pipe.

9. The pipe connection according to claim 8, wherein the pipe projection comprises a seal.

10. The pipe connection according to claim 6, wherein the pipe connection is disposed in an engine compartment of the automobile and adapted to pass charged fresh air for at least one of an internal combustion engine, air for air conditioning systems or cooling water.
